(19) United States
(12) Patent Application Publication
(10) Pub. No.: US 2005/0142329 A1
(43) Pub. Date: Jun. 30, 2005

(54) Energy efficient construction surfaces

(76) Inventors: Mark T. Anderson, Woodbury, MN (US); Peter B. Fleming, Woodbury, MN (US); Rachel A. T. Gould, Forest Lake, MN (US); Christopher L. Gross, Lake Elmo, MN (US); Daniel B. Pendergrass JR., Mendota Heights, MN (US)

Correspondence Address: 3M INNOVATIVE PROPERTIES COMPANY, PO BOX 33427, ST. PAUL, MN, 55133-3427, US

(21) Appl. No.: 10/746,829

(22) Filed: Dec. 24, 2003

(51) Int. Cl. B32B 1/00

(52) U.S. Cl. 428/143

(57) ABSTRACT

The present invention provides a non-white construction surface comprising a substrate, a first reflective coating on at least a portion of an outer surface of a substrate, such that the substrate with this first reflective coating exhibits a minimum direct solar reflectance value of at least about 25%, and a second reflective coating on at least a portion of the first reflective coating, wherein the combination of the first reflective coating and the second reflective coating provide the substrate with a reflectivity of at least about 20% at substantially all points in the wavelength range between 770 and 2500 nm.

### FIELD

The present invention relates to reflective coatings for enhancing solar reflectivity for use on exterior surfaces such as on asphalt shingle roofs, roofing tiles, and other exterior surfaces and methods to extend the effective life of such coatings.

### BACKGROUND

For energy conservation purposes, it has become more desirable to reflect solar energy from roofs and other exterior surfaces. Absorbed solar energy increases cooling energy costs in buildings. In addition, in densely populated areas, such as metropolitan areas, the absorption of solar energy increases ambient air temperatures. A primary absorber of solar energy is building roofs. It is not uncommon for ambient air temperature in metropolitan areas to be 10° F. or more warmer than in surrounding rural areas. This phenomenon is commonly referred to as the urban heat island effect. Reflecting solar energy rather than absorbing it can reduce cooling costs and thereby energy costs in buildings. In addition, reducing solar energy absorption can enhance the quality of life in densely populated areas by helping to decrease ambient air temperatures.

Solar energy reflection can be achieved by using metallic or metal-coated roofing materials. However, because the heat emittance of metallic or metal-coating roofing materials is low, such materials do not produce significant gains in energy conservation and reduced costs since such materials restrict radiant heat flow.

Reflection of solar energy can also be accomplished by using white or light-colored roofs. However, such sloped roofs are not well accepted in the marketplace for aesthetic reasons. Instead, darker roofs are preferred. However, darker roofs by their very nature absorb a higher degree of solar energy and reflect less.

Non-flat or sloped roofs typically use shingles coated with colored granules adhered to the outer surface of the shingles. Such shingles are typically made of an asphalt base with the granules embedded in the asphalt. The roofing granules are used both for aesthetic reasons and to protect the underlying base of the shingle. The very nature of such granules creates significant surface roughness on the shingle. Solar radiation thereby encounters decreased reflectivity since the radiation is scattered in a multi-scattering manner that leads to increased absorption when compared to the same coating placed on a smooth surface.

Although construction materials may have sufficiently high solar energy reflectivity when they are installed, a variety of environmental factors tend to degrade that performance. Growth of micro biota, such as algae, lichen, and moss, is a common problem on roofs in many areas especially those where exposed surfaces are often damp. In other regions, the deposit of air borne materials such as soot is a primary contributor to reduced solar energy reflectivity. These problems have been addressed as a nuisance appearance issue by the art.

The conflict between the aesthetic desire for darker construction surfaces and the energy efficiency which can be obtained through the higher solar energy rejection of white or near white surfaces has required a compromise that favors lighter colors. Although lighter colors may meet initial solar reflectivity standards such as that required for “Energy Star” labeling, they tend to lose their reflectivity over time as dirt and micro biota accumulate. Maintaining a useful or desired level of solar reflectivity for several years generally means that the initial reflectivity must be significantly higher than the eventual target and this, in turn, requires an even lighter, less desirable initial color.

In the case of the “Energy Star” labeling standard, this decline in reflectivity has been recognized by the inclusion of an exposure aging requirement. The initial solar reflectivity for steep slope roofs must be greater than 25% and must remain higher than 15% after 3 years. It is desirable to maintain an even higher reflectivity. In regions having high pollution and/or moist conditions favorable for algal growth, it may be necessary to select materials with an even higher initial reflectivity, in some instances as high as 30%, in order to retain 15% reflectivity after 3 years. This has meant that still lighter colors were required.

### SUMMARY

The present invention provides a non-white construction surface comprising a substrate, a first reflective coating on at least a portion of an outer surface of a substrate, such that the substrate with this first reflective coating exhibits a minimum direct solar reflectance value of at least about 25%, and a second reflective coating on at least a portion of the first reflective coating, wherein the combination of the first reflective coating and the second reflective coating provide the substrate with a reflectivity of at least about 20% at substantially all points in the wavelength range between 770 and 2500 nm.

In some embodiments, a biological growth inhibitor or self-cleaning component is included in one or both construction surface reflective coatings. In other embodiments, the biological growth inhibitor or self-cleaning component is provided on the construction surface and adjacent to a non-white construction surface comprising a substrate, a first reflective coating on at least a portion of an outer surface of a substrate, such that the substrate with this first reflective coating exhibits a minimum direct solar reflectance value of at least about 25%, and a second reflective coating on at least a portion of the first reflective coating, wherein the combination of the first reflective coating and the second reflective coating provide the substrate with a reflectivity of at least about 20% at substantially all points in the wavelength range between 770 and 2500 nm.

In another aspect, the invention provides a non-white construction surface comprising a substrate, a first reflective coating on at least a portion of an outer surface of a substrate, such that the substrate with this first reflective coating exhibits a minimum direct solar reflectance value of at least about 25%, and a second reflective coating on at least a portion of the first reflective coating, wherein the combination of the first reflective coating and the second reflective coating provide the substrate with a summed reflectance value of at least about 7,000 as measured in the range between 770 and 2500 nm inclusive.

In some embodiments, a biological growth inhibitor or self-cleaning component is included in one or both construction surface reflective coatings. In other embodiments, the biological growth inhibitor or self-cleaning component is provided on the construction surface and adjacent to a non-white construction surface comprising a substrate, a first reflective coating on at least a portion of an outer surface of a substrate, such that the substrate with this first reflective coating exhibits a minimum direct solar reflectance value of at least about 25%, and a second reflective coating on at least a portion of the first reflective coating, wherein the combination of the first reflective coating and the second reflective coating provide the substrate with a summed reflectance value of at least about 7,000 as measured in the range between 770 and 2500 nm inclusive.

In yet another aspect, the invention provides a non-white construction surface comprising an inorganic, non-metallic substrate, a first reflective coating on at least a portion of an outer surface of the substrate, the coated substrate exhibiting a minimum direct solar reflectance value of at least about 25%, and second reflective coating on at least a portion of the first reflective coating, wherein the combination of the first reflective coating and the second reflective coating provide the substrate with at least one of (i) a reflectivity of at least about 20% at substantially all points in the wavelength range between 770 and 2500 nm, and (ii) a summed reflectance value of at least 7000 as measured in the range between 770 and 2500 nm inclusive.

The above summary is not intended to describe each illustrated embodiment or every implementation of the present disclosure. The description that follows more particularly describes and exemplifies certain embodiments using the principles disclosed herein.

### DETAILED DESCRIPTION

One advantage of the present invention is to provide construction substrates having enhanced aesthetic characteristics and/or extended useful life while maintaining its solar energy reflecting properties. Examples of construction substrates include roofing shingles and tiles. Other features and advantages of the invention will be apparent from the following detailed description of the invention and the claims.

The present invention includes a non-white construction surface comprising a coated substrate such as granules for use in roofing that have enhanced solar reflectivity relative to conventional roofing granules. The enhanced reflectivity is obtained by first providing a reflective primary or undercoating to the substrate granules and then providing a secondary coating over the undercoating with the secondary coating containing a non-white pigment. In some embodiments, the pigment may have enhanced reflectivity in the near-infrared (NIR) (700-2500 nm) portion of the solar spectrum.

In some embodiments, the substrate is inorganic and non-metallic. Although roofing granules will be referred to throughout the description, the undercoating and outer coating may be placed on other construction surfaces such as glass, tile such as clay or concrete tile, roof substances, concrete, or rock, which materials can be, but need not be, in granular form. In some embodiments, the construction surface coatings will include a biological growth inhibitor or a self-cleaning component in or on the coating. In some embodiments, the biological growth inhibitor or self-cleaning component will be adjacent to the construction surface coating rather than being a constituent of the construction surface coating itself. In yet other embodiments, a biological growth inhibitor or a self-cleaning component will be present in both the coating and adjacent to the coated construction surface.

Methods for making such construction surfaces are described in U.S. application Ser. No. 10/680,693, filed on Oct. 7, 2003. Although these coatings are more efficient reflectors of solar energy, allowing them to be formulated to achieve darker colors at a reflectivity equivalent to earlier coatings, their performance is still subject to degradation by soiling or by staining due to micro biotic growth. The initial reflectivity may be maintained for an extended period of time by including at least one of a biological growth inhibitor or a self-cleaning component on the construction surface.

In some embodiments, the biological growth inhibitor may include metal compounds, particularly oxides such as metal oxides selected from TiO₂, ZnO, WO₃, SnO₂, CaTiO₃, Fe₂O₃, MoO₃, Nb₂O₅, TiXZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, CuO, SiO₂, MoS₂, InPb, RuO₂, CeO₂, Ti(OH)₄, or combinations thereof. Other copper compounds useful as biological growth inhibitors in the invention include cupric bromide, cupric stearate, cupric sulfate, cupric sulfide, cuprous cyanide, cuprous thiocyannate, cuprous stannate, cupric tungstate, cuprous mercuric iodide, and cuprous silicate, or mixtures thereof. The term biological growth inhibitor includes both those materials which kill micro biota and those which significantly retard the growth of micro biota. In other embodiments, the biological growth inhibitor may comprise organic components such as those described in PCT Publication WO 2002/10244. In some embodiments, a biocide or biological growth inhibitor may be incorporated into one or both of the coatings of the construction surface. In other embodiments, it may be applied as a separate coating. In some embodiments, it may be periodically replenished or replaced.

In other embodiments, a biocide or biological growth inhibitor may be present on the construction surface as a separate element. For example, copper containing roofing granules, available from 3M Company, St. Paul, Minn., as #7000, #7022, #7050, or #7070, may be commingled with the non-white reflective granules of U.S. application Ser. No. 10/680,693 to provide a roofing shingle having an initial solar reflectivity approximating that of a roofing shingle haying only the non-white granules, but providing an extended life during which the reflectivity remains greater than an arbitrarily selected fraction of the initial reflectivity. Biological growth inhibitors are typically used in an effective amount to provide a biological growth inhibition for an extended period of time. Examples of such time periods include from 2 to 5 years, 3 to 7 years, 4 to 10 years, 5 to 15 years, greater than 10 years, greater than 15 years, and greater than 20 years.

Alternatively, the reflective granules may be reformulated to have a darker initial color and will maintain the desired degree of reflectivity remaining after an arbitrary time interval during which soiling or micro biotic staining occurs.

In some embodiments, the self-cleaning component may include photocatalysts. Photocatalysts, upon activation or exposure to sunlight, establish both oxidation and reduction sites. These sites are capable of preventing or inhibiting the growth of algae on the substrate or generating reactive species that inhibit the growth of algae on the substrate. In other embodiments, the sites generate reactive species that inhibit the growth of biota on the substrate. Photocatalytic particles conventionally recognized by those skilled in the art are suitable for use with the present invention. Suitable photocatalysts include, but are not limited to, TiO₂, ZnO, WO₃, SnO2, CaTiO₃, Fe₂O₃, MoO₃, Nb₂O₅, TiXZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, or combinations thereof. In some embodiments, the transition metal oxide photocatalyst is nanocrystalline anatase TiO₂. Photocatalytic elements are also capable of generating reactive species which react with organic contaminants converting them to materials which volatilize or rinse away readily.

It has been discovered that roofing granules comprising a base mineral coated with a reflective primary or undercoat and a secondary or outer coating containing non-white pigments exhibit enhanced solar reflectivity with respect to granules of similar visible color having a single coating. In some embodiments, the resulting solar reflectivity exceeds at least 20% at the wavelengths of interest. Solar reflectivity values of at least 25% meet the present steep slope roofing solar reflectivity standard set forth by the U.S. Environmental Protection Agency (EPA) under the program entitled “Energy Star.” The phrase solar reflectivity and direct solar reflectance are used interchangeably in the present application. The EPA permits manufacturers to use the designation “Energy Star” for those roofing products that meet certain energy specifications.

In some embodiments, the present invention employs colored pigments that exhibit enhanced reflectivity in the NIR portion of the solar spectrum as compared to previous colorants. The NIR comprises approximately 50-60% of the sun's incident energy. Improved reflectivity in the NIR portion of the solar spectrum leads to significant gains in energy efficiency and such pigments are useful in some embodiments of the present invention.

Direct solar reflectance means the fraction reflected of the incident solar radiation received on a surface perpendicular to the axis of the radiation within the wavelength range of 300 to 2500 nm as computed according to a modification of the ordinate procedure defined in ASTM Method G159. A spreadsheet, available upon request from Lawrence Berkley Laboratory, Berkley, Calif., combining the direct and hemispherical Solar Irradiance Air Mass 1.5 data from ASTM Method G159 was used to compute interpolated irradiance data at 5 nm intervals in the region of interest. The 5 nm interval data was used to create weighting factors by dividing the individual irradiances by the total summed irradiance from 300 to 2500 nm. The weighting factors were then multiplied by the experimental reflectance data taken at 5 nm intervals to obtain the direct solar reflectance at those wavelengths.

By summed reflectance value is meant the sum of the numerical value of the discrete percentage reflectance measured at 5 nm intervals in the range between 770 and 2500 nm inclusive.

CIELAB is the second of two systems adopted by CIE in 1976 as models that better showed uniform color spacing in their values. Color opposition correlates with discoveries that somewhere between the optical nerve and the brain, retinal color stimuli are translated into distinctions between light and dark, red and green, and blue and yellow. CIELAB indicates these values with three axes: L*, a*, and b*. The central vertical axis represents lightness (signified as L*) whose values run from 0 (black) to 100 (white). The color axes are based on the fact that a color cannot be both red and green, or both blue and yellow, because these colors oppose each other. On each axis, the values run from positive to negative. On the a-a′ axis, positive values indicate amounts of red while negative values indicate amounts of green. On the b-b′ axis, yellow is positive and blue is negative. For both axes, zero is neutral gray.

For the purposes of this application, articles having a color falling within the inverted conical volume defined by the equation:
−(L*)+[((L₀*)+(y(a*)\hat{ }2+z(b*)\hat{ }2)\hat{ }0.5)/x]≦0
where L₀*=67, x=1.05, y=1.0, z=1.0 and the values, L*, a*, and b*, are defined on the CIE L*a*b* scale are said to be white and articles having a color falling outside the cone are said to be non-white.

Values of the color space corresponding to white fall within the cone close to the vertical L* axis, are not strongly colored as indicated by their small displacements along either or both of the a* and b* axes, and have a relatively high degree of lightness as indicated by an L* greater than L₀*. L₀* is the vertex of the cone. For the purposes of this application, “darker” means that the darker article has an L* value at least about 1 unit lower, preferably about 2 units lower, than the L* value associated with the article to which it is compared.

Bituminous sheet materials such as roofing shingles may be produced using the granules of the invention. Roofing shingles typically comprise materials such as felt, fiberglass, and the like. Application of a saturant or impregnant such as asphalt is believed essential to entirely permeate the felt or fiberglass base. Typically, applied over the impregnated base is a waterproof or water-resistant coating, such as asphaltum, upon which is then applied a surfacing of mineral granules, which completes the conventional roofing shingle.

Various other layers can be used, for example, films useful for weather or impact resistance, reflective films, etc.

The following examples are provided to further illustrate aspects of the invention. The examples are not intended to limit the scope of this invention in anyway.

### EXAMPLES

Test Method 1

Reflectance measurements were made with a Perkin Elmer Lambda 900 Spectrophotometer fitted with a PELA-1000 integrating sphere accessory. This sphere is 150 mm (6 inches) in diameter and complies with ASTM Methods E903, D1003, and E308 as published in “ASTM Standards on Color and Appearance Measurement,” Third Ed., ASTM, 1991. Diffuse Luminous Reflectance (DLR) was measured over the spectral range of 250-2500 nm. UV-visible integration was set at 0.44 seconds. Slit width was 4 nm. A “trap” was utilized to eliminate complications arising from specular reflectance.

Measurements were all made with a clean and optically flat fused silica (quartz) plate in front of the sample or in front of a standard white plate. A cup having a diameter of about 50 mm and a depth of about 10 mm was filled with the granules to be characterized.

Test Method 2

L*a*b* color measurements were made using a Labscan XE spectrophotometer (Hunter Associates Laboratory, Reston, Va.) fitted with a sample holder and using a traversing roller to ensure that a uniformly level surface was prepared for measurement. The holder was filled to a depth of about 5 mm to ensure that the measured values were attributable to the granules. For a more detailed description of the sample holder and sample preparation refer to U.S. Pat. No. 4,582,425, which is herein incorporated by reference.

Test Method 3

The granules to be tested were screened to provide a size cut that passed through 16 mesh and were retained on 20 mesh US Standard screen sleeves. The initial copper content of the screened granules was determined by placing 15 grams (g) of the screened granules into a polyethylene snap-ring, holding ring, 31 mm diameter, open-ended cup (Spex CertiPrep, Metuchen, N.J.). The base of the assembled sample cup was lined with polypropylene window film, 0.2 mil (5 micrometers) thick, 2⅞inches wide (7.3 cm) (Spex CertiPrep, Metuchen, N.J.). Taking care not to tap or otherwise cause the granules to rearrange in the cup, the cup was placed onto the probe of an XMET 880 X-ray Fluorescence (XRF) instrument (Metorex, Ewing, N.J.) equipped with a surface analysis probe set with a 60 mCi Cm-244 excitation source. Sample time was set to 20 seconds. The instrument had been calibrated with a series of granules of known copper content and data is reported in units of g/metric ton.

Fifty grams of screened granules were placed into a 500 mL Erlenmeyer flask containing 200 mL of a boiling 5% Al₂(SO₄)₃. The granules were allowed to boil in the aluminum sulfate solution for exactly 3 minutes. The flask was then removed from the hot plate and the supernatant immediately decanted. Care was taken not to lose any of the granules from the flask. The granules were rinsed three times with 200 mL deionized water, taking care with each decantation to avoid granule loss. The granules were placed on a paper towel on a drying rack in an oven for 12 minutes at 230° F. (110° C.). Granules were then removed from the oven, allowed to cool and the final copper content again determined according to Test Method 3B. The difference between the XRF readings before and after extraction is reported as the Leached Amount. The units are kg/metric ton.

Test Method 4

Relative photocatalytic activities of granules was determined via a rapid chemical test that provided an indication of the rate at which hydroxyl radicals were produced by UV-illuminated photocatalyst in or on the granules. The results of this test have been shown to correlate with the photocatalytic performance of roofing granules in field testing.

Approximately 40 g of granules to be tested was weighed, washed with deionized water, dried, and transferred to a 500 mL crystallization dish. The granules were spread evenly on the bottom of the dish. To the dish was added 500 g of 4×10⁻⁴ M aqueous disodium terephthalate solution. Agitation was provided by a magnetic stirring bar placed in the bottom of a submerged small Petri dish resting on the granules. The small Petri dish served to prevent possible abrasion of the granule coating by the stirring bar, resulting in suspended particles that could lead to erroneous activity readings. The large crystallizing dish was placed on a magnetic stirrer under a bank of UV lights consisting of 4, equally spaced, 4 ft. (1.2 m) long black light bulbs (Sylvania 350 BL 40W F40/350BL) powered by two specially designed ballasts (Action Labs, Inc., Woodville, Wis.) to increase the intensity of emitted light. The height of the bulbs was adjusted to provide ˜2.3 mW/cm² UV flux. Light Flux was measured using a VWR (Westchester, Pa.) UV Light Meter (Model 21800-016) equipped with a UVA Radiometer model UVA365 and a wide band wavelength of 320-390 nm. During irradiation, approximately 3 mL of the solution was removed at approximately 5 minute intervals with a pipet and transferred to a disposable 4-window polymethylmethacrylate or quartz cuvette. The sample in the cuvette was placed into a Fluoromax-3 spectrofluorimeter (SPEX Fluorescence Group, Jobin Yvon, Inc. Edison, N.J.). The fluorescence intensity of the sample at λₑₓ 314 nm, λₑₘ 424 was plotted versus sample irradiation time. The fluorescence intensity vs. time plots for different roofing granule formulations can be plotted in the same figure for comparison. The slope of the linear portion of the curves (slope of the initial 3-5 datapoints) is indicative of the relative photocatalytic activity of different granule formulations.

Granule Coating Method

The slurry components indicated in Tables 1-3 were combined in a vertical mixer. 1000 parts by weight of substrate were pre-heated to 90-95° C. and then combined with the indicated amount of slurry in a vertical or horizontal mixer. Example 1 used Grade #11 uncoated roofing granules as the substrate. Examples 2-4 used granules produced as in Example 1 as the substrate. The slurry coated granules were then fired in a rotary kiln (natural gas/oxygen flame) reaching 850° C. for Example 3 and 750-850° C. for the remaining Examples over a period of about 10 minutes. Following firing, the granules were allowed to cool to room temperature.

Test Method 5

Cultures of Neochloris, a green unicellular algae cultured from an asphalt shingle in Florida, maintained in nutrient medium described below, were used in a laboratory algae challenge test to determine the viability of algae innoculated onto a simulated shingle substrate. Algae challenge tests were carried out in an environmental chamber (diurnal incubator Model #RI-50-555-ABA; REVCO, Asheville, N.C.) maintained at 24° C. ±2° C. The light cycle was set for 16 hours light and 8 hours darkness. Small petri dishes containing approximately 2 g roofing granules embedded in 10 g melted asphalt were prepared. The embedded granules were washed with deionized water 3 times and dried before starting the algae test. Two sets of each granule type were prepared.

Algae Growth Culture Nutrient Medium

| Chemical Ingredient | g/L |
|---|---|
| NH₄NO₃ | 0.071 |
| KH₂PO₄ | 0.068 |
| Na₂HPO₄ | 0.071 |
| MgSO₄.7H₂O | 0.0075 |
| Na₂CO₃ | 0.002 |
| CaCl₂.2H₂O | 0.0027 |
| FeCl₃.6H₂O | 0.000054 |
| H₃BO₄ | 0.000286 |
| MnCl₂.4H₂O | 0.00018 |
| ZnSO₄.7H₂O | 0.000022 |
| NaMoO₄.2H₂O | 0.000039 |
| CuSO₄.5H₂O | 0.000008 |
| Co(NO₃)₂.6H₂O | 0.000005 |
| NaOH (1 N) | adjust pH to 6.8-7.0 |

Three-week old algae suspensions of Neochloris algae were pooled in a 50 mL sterile centrifuge tube and centrifuged for 15 minutes at 200 to 300 g to pelletize the cells. The cells were resuspended in nutrient medium prepared without MnCl₂ and centrifuged again. The cells were resuspended in 30 mL of medium prepared without MnCl₂ that was then used to inoculate the granule dishes. 2 mL of this dilute, slightly pale green, washed algae cell suspension was added to each dish and the dishes were placed in UV transparent zip-lock plastic bags. One set of dishes was placed under UV lamps, the other under cool white fluorescent lamps as described in the table. Light intensities were measured using the UV Light Meter described in Test Method 4. And Visible light intensity measured using a Light Meter Model DLM2 from Universal Enterprises, Inc., Beaverton, Oreg.

| Lamp Type | UV Light Intensity | Visible Light Intensity |
|---|---|---|
| Sylvania 350 Black Light | 271 μW/cm² | 1340 Lux |
| F20T12/350BL 20W | | |
| Sylvania Cool White | 6.5 μW/cm² | 1945 Lux |
| F20T12/CW 20W | | |

Water level was checked daily and replenished if necessary. On day seven, the dishes were checked to see if the controls have produced sufficient growth for the green of the algae to be visible. If sufficient growth is present, the test was terminated and the degree of efficacy determined using a subjective rating. In the dishes where there was no green visible on the granules, a stereomicroscope was used to determine if any algae was growing on the granules or on the asphalt. If the growth in the controls was light, 1 mL of nutrient medium prepared without MnCl₂ was added to each dish and the cells were grown another 4 days before doing the evaluations of efficacy.

Materials

The following materials were used in the Examples:
Sodium silicate solution (39.4% solids, 2.75 ratio SiO₂ to Na₂O) available from PQ Corp., Valley Forge, Pa.
Kaolin clay (available as Snobrite™ from Unimin Corp., New Canaan, Conn.
Dover Clay, a kaolin clay (available from W. R. Grace Company Columbus, Md.)
Borax (Sodium Borate, 5 Mol, typical composition: 21.7% Na₂O, 48.8% B₂O₃, and 29.5% H₂O) available from U.S. Borax, Boron, Calif.
Titanium dioxide (Tronox® CR-800, typical composition: 95% TiO₂, alumina treated) available from the Kerr-McGee Corp., Hamilton, Miss.
Pigments (10411 Golden Yellow, 10241 Forest Green, V-3810 Red, V-9250 Bright Blue) available from Ferro Corp., Cleveland, Ohio
Grade #11 uncoated roofing granules (available from 3M Company, St. Paul, Minn.) specified by the following ranges (as per ASTM D451):
WA9300 Oil-free white roofing granules (available from 3M Company)
Kronos 1000 Titanium dioxide (available from Kronos, Inc., Chelmsford, Mass.)
FC-129 (Fluorochemical surfactant) available from 3M Company, St. Paul, Minn.
LR7070 Copper releasing roofing granules (available from 3M Company)

### Examples 1-3

Granules were prepared using the Granule Coating Method and the coating components listed in Table 1. Quantities are in grams unless otherwise noted.

TABLE 1

| Component | Ex. 1 | Ex. 2 | Ex. 3 |
|---|---|---|---|
| Uncoated Granules | 2000 | 2000 | 2000 |
| Sodium Silicate (PQ Corp.) | 40 | 40 | 56 |
| Water | 15 | 15 | 26.4 |
| Kaolin Clay (SNOBRITE) | 20 | 20 | — |
| Dover Clay (W. R. Grace) | — | — | 25 |
| Tronox ® CR-800 | 2 | — | 10 |
| Ferro 10550 Brown (Ferro) | 0.5 | 0.5 | — |
| Ferro 10415 Yellow Forest | 2.5 | 2.5 | — |
| Green (Ferro) | | | |
| Ferro V-13810 Red (Ferro) | 0.075 | 0.075 | — |
| Ferro 12650 Camo Green | 0.25 | 0.25 | — |
| (Ferro) | | | |
| Borax ® (U.S. Borax Inc.) | 1 | 1 | 1.3 |
| Kronos 1000 Titanium | — | 20 | — |
| Dioxide | | | |
| FC-129 | — | — | 0.03 |
| Cu₂0 | — | — | 70 |

Some of the granules of the examples were provided with a second coating according to the Granule Coating Method using the coating components listed in Table 2. Quantities are in grams unless otherwise noted.

TABLE 2

| Component | Ex. 1 | Ex. 2 | Ex. 3 |
|---|---|---|---|
| Sodium Silicate (PQ Corp.) | — | — | 56 |
| Water | — | — | 26.4 |
| Tronox ® CR-800 | — | — | 1.3 |
| Dover Clay (W. R. Grace) | — | — | 25 |
| Borax ® (U.S. Borax Inc.) | — | — | 1.3 |
| FC-129 | — | — | 0.03 |
| Cu₂0 | — | — | 25 |

Selected granules of the examples were provided with a third coating according to the Granule Coating Method using the coating components listed in Table 3. Quantities are in grams unless otherwise noted.

TABLE 3

| Component | Ex. 1 | Ex. 2 | Ex. 3 |
|---|---|---|---|
| Sodium Silicate (PQ Corp.) | — | — | 40 |
| Water | — | — | 15 |
| Tronox ® CR-800 | — | — | 2 |
| Kaolin Clay (W. R. Grace) | — | — | 20 |
| Borax ® (U.S. Borax Inc.) | — | — | 1 |
| Ferro 10550 Brown (Ferro) | — | — | 0.5 |
| Ferro 10415 Yellow Forest | — | — | 2.5 |
| Green (Ferro) | | | |
| Ferro V-13810 Red (Ferro) | — | — | 0.075 |
| Ferro 12650 Camo Green | — | — | 0.25 |
| (Ferro) | | | |

### Example 4

Example 4 was a blend of 90 wt % granules of Example 1 and 10 wt % of a copper releasing granule available as LR707 from 3M Company.

Control was a blend of 90 wt % oil-free WA9300 roofing granules available from 3M Company and 10 wt % of a copper releasing granule available as LR7070 from 3M Company. This granule blend, together with WA9300 alone, provided known performance for the Algal Growth Inhibition test (Method 5). WA9300 alone was expected to allow algal growth, while the blended granules are known to be effective in inhibiting algal growth.

The results of testing according to Test Methods 1-5 are summarized in Table 4.

TABLE 4

| | Ex. 1 | Ex. 2 | Ex. 3 | Ex. 4 | Control | WA9300 |
|---|---|---|---|---|---|---|
| L* | 60.99 | 59.63 | 50.82 | 60.08 | — | — |
| a* | 3.26 | 5.23 | 4.57 | 2.77 | — | — |
| b* | 14.07 | 14.78 | 9.63 | 12.71 | — | — |
| Base | 30 | 29 | 25 | — | — | — |
| Layer | | | | | | |
| Solar | | | | | | |
| Reflec- | | | | | | |
| tance | | | | | | |
| (Method | | | | | | |
| 1) | | | | | | |
| Granule | 29 | 29 | 25 | 29 | — | — |
| Direct | | | | | | |
| Solar | | | | | | |
| Reflec- | | | | | | |
| tance | | | | | | |
| (Method | | | | | | |
| 1) | | | | | | |
| Minimum | 22.50 | 16.62 | 23.78 | 22.47 | — | — |
| Granule | | | | | | |
| Solar | | | | | | |
| Reflec- | | | | | | |
| tance | | | | | | |
| (Method | | | | | | |
| 1) | | | | | | |
| Summed | 9801.3 | 9290.5 | 10248.6 | 9910.3 | — | — |
| Reflec- | | | | | | |
| tance | | | | | | |
| (Method | | | | | | |
| 1) | | | | | | |
| Leached | — | — | 1.5 | — | — | — |
| Amount | | | | | | |
| (Method | | | | | | |
| 3) | | | | | | |
| Initial | — | — | 6.1 × 10⁵ | — | — | 1.5 × 10⁴ |
| Slope | | | | | | |
| (Method | | | | | | |
| 4) | | | | | | |
| Algae | No | Yes | Yes | Yes | Yes | No |
| Growth | | | | | | |
| Inhibition | | | | | | |
| (Method | | | | | | |
| 5) | | | | | | |

### Examples 5-7

Shingles were prepared using the granules of Examples 2-4 respectively.

Molten asphalt (Trumbul Asphalt Supply, Minneapolis, Minn.) heated to 375° F. (190° C.) was applied to by gravity feed to a moving asphalt impregnated fiberglass matting (A.H. Bennett Co, Minneapolis, Minn.) web. The asphalt thickness was metered by a doctor bar to a thickness of approximately 2 mm. The cooled mat was cut into 0.0058 m² pieces and heated in a 176° F. (80° C.) oven for 3 minutes until the asphalt softened and began to flow. Granules (from Examples 2-5) were applied to the heated mat immediately. Approximately 100 g of granules were placed in a glass jar with equally spaced holes (3 mm diameter) punched into the lid. The glass jar was held 9 inches (22.8 m) above the heated asphalt and keeping the jar level, granules dropped onto the surface of the asphalt. Granules were embedded into the asphalt by using the base of a 250 mL Erlenmeyer flask and applying even pressure strokes across the asphalt surface. Excess granules were collected and reapplied in a similar fashion. The granule impregnated asphalt panel was allowed to cool prior to evaluation. The results are summarized in Table 5.

TABLE 5

| | Ex. 5 | Ex. 6 | Ex. 7 |
|---|---|---|---|
| L* | 59.04 | 50.75 | 59.0 |
| a* | 5.03 | 4.31 | 2.55 |
| b* | 14.48 | 9.68 | 11.9 |
| Granule | 33 | 29 | 31 |
| Direct | | | |
| Solar | | | |
| Reflectance | | | |
| (Method 1) | | | |
| Minimum | 20.6 | 27.3 | 25.2 |
| Granuyle | | | |
| Solar | | | |
| Reflectance | | | |
| (Method 1) | | | |
| Summed | 10756 | 11601 | 10742 |
| Reflectance | | | |
| (Method 1) | | | |
| Initial | 2.4 × 10⁵ | — | — |
| Slope | | | |
| (Method 4) | | | |

All patents, patent applications, and publications cited herein are each incorporated by reference, as if individually incorporated. Foreseeable modifications and alterations of this invention will be apparent to those skilled in the art without departing from the scope and spirit of this invention. This invention should not be restricted to the embodiments that are set forth in this application for illustrative purposes.

1. A non-white construction surface comprising:
a substrate;
a first reflective layer on at least a portion of an outer surface of the substrate, wherein the combination of reflective layer and substrate exhibit a minimum direct solar reflectance value of at least about 25%;
a second reflective layer on at least a portion of the first reflective layer, wherein the combination of the first reflective layer and the second reflective layer provide the substrate with a reflectivity of at least about 20% at substantially all points in the wavelength range between 770 and 2500 nm; and
a preservation agent selected from a biological growth inhibitor, a self-cleaning component, or combinations thereof.

2. The surface of claim 1 further comprising a third layer, said third layer present between the substrate and the first layer, between the first and second layers, or on the second layer.

3. The surface of claim 1 wherein the preservation agent is part of the first layer.

4. The surface of claim 1 wherein the preservation agent is part of the second layer.

5. The surface of claim 1 wherein the preservation agent is part of the third layer.

6. The surface of claim 1 wherein the preservation agent is part of two or more of the first layer, the second layer, and the third layer.

7. The surface of claim 1 wherein the preservation agent is part of the first layer, the second layer, and the third layer.

8. The surface of claim 1 wherein the reflective layers are present in regions, and wherein the preservation agent is present in regions of the substrate adjacent to reflective layer regions.

9. The surface of claim 8 wherein the preservation agent is present in regions of the substrate not covered by the first or second coating.

10. The surface of claim 1 wherein the substrate is an inorganic, non-metallic substrate.

11. The surface of claim 1 wherein the substrate is selected from clay, concrete, rock, and combinations thereof.

12. The surface of claim 1 wherein the substrate comprises inorganic granules.

13. The surface of claim 12 wherein the substrate comprises a portion of inorganic granules having reflective layers, and a portion of inorganic granules having a preservation agent.

14. The surface of claim 1 wherein the substrate comprises at least a portion of a roofing shingle.

15. A non-white construction surface comprising:
a substrate;
a first reflective layer on at least a portion of an outer surface of the substrate, the substrate with the reflective layer exhibiting a minimum direct solar reflectance value of at least about 25%;
a second reflective layer on at least a portion of the first reflective layer, wherein the combination of the first reflective layer and the second reflective layer provide the substrate with a summed reflectance value of at least about 7,000 as measured in the range between 770 and 2500 nm inclusive; and
a preservation agent selected from a biological growth inhibitor, a self-cleaning component, or combinations thereof.

16. The surface of claim 15 further comprising a third layer, said third layer present between the substrate and the first layer, between the first and second layers, or on the second layer.

17. The surface of claim 15 wherein the preservation agent is part of the first layer.

18. The surface of claim 15 wherein the preservation agent is part of the second layer.

19. The surface of claim 15 wherein the preservation agent is part of the third layer.

20. The surface of claim 15 wherein the preservation agent is part of two or more of the first layer, the second layer, and the third layer.

21. The surface of claim 15 wherein the preservation agent is part of the first layer, the second layer, and the third layer.

22. The surface of claim 15 wherein the reflective layers are present in regions, and wherein the preservation agent is present in regions of the substrate adjacent to reflective layer regions.

23. The surface of claim 22 wherein the preservation agent is present in regions of the substrate not covered by the first or second coating.

24. The surface of claim 15 wherein the substrate is an inorganic, non-metallic substrate.

25. The surface of claim 15 wherein the substrate is selected from clay, concrete, rock, and combinations thereof.

26. The surface of claim 15 wherein the substrate comprises inorganic granules.

27. The surface of claim 26 wherein the substrate comprises a portion of inorganic granules having reflective layers, and a portion of inorganic granules having a preservation agent.

28. The surface of claim 15 wherein the substrate comprises at least a portion of a roofing shingle.

29. A method of producing a non-white construction surface comprising:
providing a first coating to at least a portion of an outer surface of a substrate;
curing the first coating to form a first reflective layer on a substrate, the first reflective layer exhibiting a minimum direct solar reflectance value of at least about 25%;
providing a second coating over at least a portion of the coated substrate; and
curing the second coating to form a second reflective layer wherein the combination of the first reflective layer and the second reflective layer provide at least one of:
(i) a reflectivity of at least about 20% at substantially all points in the wavelength range between 770 and 2500 nm; and
(ii) a summed reflectance value of at least 7000 as measured in the range between 770 and 2500 nm inclusive; and
providing a preservation agent on the substrate, said preservation agent selected from a biological growth inhibitor, a self-cleaning component, or combinations thereof.

30. The surface of claim 29 further comprising a third layer, said third layer present between the substrate and the first layer, between the first and second layers, or on the second layer.

31. The surface of claim 29 wherein the preservation agent is part of the first layer.

32. The surface of claim 29 wherein the preservation agent is part of the second layer.

33. The surface of claim 29 wherein the preservation agent is part of the third layer.

34. The surface of claim 29 wherein the preservation agent is part of two or more of the first layer, the second layer, and the third layer.

35. The surface of claim 29 wherein the preservation agent is part of the first layer, the second layer, and the third layer.

36. The surface of claim 29 wherein the reflective layers are present in regions, and wherein the preservation agent is present in regions of the substrate adjacent to reflective layer regions.

37. The surface of claim 36 wherein the preservation agent is present in regions of the substrate not covered by the first or second coating.

38. The surface of claim 29 wherein the substrate is an inorganic, non-metallic substrate.

39. The surface of claim 29 wherein the substrate is selected from clay, concrete, rock, and combinations thereof.

40. The surface of claim 29 wherein the substrate comprises inorganic granules.

41. The surface of claim 40 wherein the substrate comprises a portion of inorganic granules having reflective layers, and a portion of inorganic granules having a preservation agent.

42. The surface of claim 29 wherein the substrate comprises at least a portion of a roofing shingle.

43. A non-white shingle comprising:
a shingle substrate;
a first reflective layer on at least a portion of an outer surface of the shingle substrate, wherein the combination of reflective layer and substrate exhibit a minimum direct solar reflectance value of at least about 25%;
a second reflective layer on at least a portion of the first reflective layer, wherein the combination of the first reflective layer and the second reflective layer provide the shingle substrate with a reflectivity of at least about 20% at substantially all points in the wavelength range between 770 and 2500 nm; and
a preservation agent selected from a biological growth inhibitor, a self-cleaning component, or combinations thereof.

44. A non-white shingle surface comprising:
a shingle substrate;
a first reflective layer on at least a portion of an outer surface of the shingle substrate, the substrate with the reflective layer exhibiting a minimum direct solar reflectance value of at least about 25%;
a second reflective layer on at least a portion of the first reflective layer, wherein the combination of the first reflective layer and the second reflective layer provide the shingle substrate with a summed reflectance value of at least about 7,000 as measured in the range between 770 and 2500 nm inclusive; and
a preservation agent selected from a biological growth inhibitor, a self-cleaning component, or combinations thereof.
